(19) United States
(12) Patent Application Publication
(10) Pub. No.: US 2023/0153887 A1
(43) Pub. Date: May 18, 2023

(54) DISENTANGLED COMMODITY RECOMMENDATION METHOD AND APPARATUS, DEVICE, AND STORAGE MEDIUM

(71) Applicant: Tsinghua University, Beijing (CN)

(72) Inventors: Wenwu ZHU, Beijing (CN); Xin WANG, Beijing (CN); Hong CHEN, Beijing (CN)

(73) Assignee: Tsinghua University, Beijing (CN)

(21) Appl. No.: 17/986,912

(22) Filed: Nov. 15, 2022

(30) Foreign Application Priority Data
Nov. 16, 2021 (CN) 202111355958.9

(51) Int. Cl. G06Q 30/06; G06Q 30/02

(52) U.S. Cl. CPC G06Q 30/0631; G06Q 30/0201; G06Q 30/0204

(57) ABSTRACT

A disentangled commodity recommendation method includes: receiving information of commodities to be recommended and historical behavioral information of a user, the historical behavioral information including a clicked commodity sequence, an unclicked commodity sequence, a disliked commodity sequence and behavioral time information of the user; filtering the clicked commodity sequence and the unclicked commodity sequence according to the disliked commodity sequence to obtain representations of interested commodities of the user; filtering the representations of the interested commodities according to the behavioral time information of the user and the information of the commodities to be recommended to obtain representations of historical interested commodities of the user; clustering and aggregating the representations of the historical interested commodities to obtain a plurality of disentangled representations of the user; and determining whether the commodities to be recommended are the interested commodities of the user according to the plurality of disentangled representations.

### CROSS REFERENCE TO THE RELATED APPLICATIONS

This application is based upon and claims priority to Chinese Patent Application No. 202111355958.9, filed on Nov. 16, 2021, the entire contents of which are incorporated herein by reference.

### TECHNICAL FIELD

Embodiments of the present application relates to the technical field of data processing and, more particularly, to a disentangled commodity recommendation method and apparatus, a device and a storage medium.

### BACKGROUND

Disentangled representation learning is an effective way to mine different aspects of user intentions and improves the accuracy and interpretability of a recommendation system. The existing recommendation system obtains the disentangled intentions from the user's positive feedback like purchasing or clicking, and then recommend commodities to the user based the learned disentangled intentions.

In the prior art, the interests of the user are obtained only from the positive feedback of the user, the learned user interests are prone to homogeneity and simplification, which affects a click-through rate of the user on the recommended commodities. Moreover, the prior art cannot deal with a complex relationship between the disentangled interests of the user and multiple feedbacks in the multi-feedback scenario, and cannot deal with a lot of noise contained in the multiple feedbacks, so the prior art cannot be directly used in the multi-feedback scenario. On the other hand, the existing multi-feedback recommendation technology doesn't disentangle the interests of the user, cannot describe the interest of the user in all aspects, lacks interpretability, and has a low accuracy rate of recommending commodities.

### SUMMARY

Embodiments of the present application provide a disentangled commodity recommendation method and apparatus, a device and a storage medium, and aim at improving accuracy of recommending commodities to users.

A first aspect of the embodiments of the present application provides a disentangled commodity recommendation method, wherein the method includes:

receiving information of commodities to be recommended and historical behavioral information of a user, where the historical behavioral information including a clicked commodity sequence, an unclicked commodity sequence, a disliked commodity sequence and behavioral time information of the user;

filtering the clicked commodity sequence and the unclicked commodity sequence according to the disliked commodity sequence to obtain representations of commodities the user is really interested in;

filtering the representations of the interested commodities of the user according to the behavioral time information of the user and the information of the commodities to be recommended to obtain representations of historical interested commodities of the user;

clustering and aggregating the representations of the historical interested commodities to obtain the disentangled representations of the user; and

determining whether the commodities to be recommended are the interested commodities of the user according to the disentangled representations.

Optionally, the method is implemented based on a commodity recommendation model, and training steps of the commodity recommendation model include:

taking a set composed of a plurality of groups of user information and corresponding commodity information thereof as a training set, and inputting the training set into the commodity recommendation model; and

selecting, by the commodity recommendation model, a sample with corresponding difficulty in the training set for learning according to a current learning state, and adjusting difficulty distribution of the sample at a corresponding rate, and obtaining a trained commodity recommendation model after learning.

Optionally, the selecting, by the commodity recommendation model, the sample with corresponding difficulty in the training set for learning according to the current learning state, includes:

obtaining a corresponding loss value after the commodity recommendation model learns samples in the training set;

comparing the loss value with a preset hyper-parameter, and determining difficulties of learning the samples according to a comparison result; and

determining the sample with the corresponding difficulty for learning according to parameters of the commodity recommendation model.

Optionally, filtering the clicked commodity sequence and the unclicked commodity sequence according to the disliked commodity sequence to obtain the representations of the interested commodities of the user, includes:

inputting the clicked commodity sequence, the unclicked commodity sequence and the disliked. commodity sequence into an encoder based on a multi-head attention mechanism for encoding, to obtain representations of clicked commodities, representations of unclicked commodities and representations of disliked commodities;

performing average pooling on the representations of the disliked commodities to obtain a negative tendency representation of the user; and

filtering the representations of the clicked commodities and the representations of the unclicked commodities based on the negative tendency representation to obtain the representations of the interested commodities of the user.

Optionally, filtering the representations of the clicked commodities and the representations of the unclicked commodities based on the negative tendency representation to obtain the representations of the interested commodities of the user, includes:

performing similarity calculation between the representations of the clicked commodities and the representations of the unclicked commodities and the negative tendency representation; and

filtering the representations of the clicked commodities and the representations of the unclicked commodities according to a similarity calculation result to obtain the representations of the interested commodities of the user.

Optionally, filtering the representations of the interested commodities of the user according to the behavioral time information of the user and the information of the commodities to be recommended to obtain the representations of the historical interested commodities of the user, includes:

performing corresponding weight assignment on the representations of the interested commodities according to the behavioral time information;

performing corresponding weight assignment on the representations of the interested commodities according to the information of the commodities to be recommended; and

taking the representations of the interested commodities after the weight assignment as the representations of the historical interested commodities of the user.

Optionally, clustering and aggregating the representations of the historical interested commodities to obtain the plurality of disentangled representations of the user, includes:

calculating a distance between the representations of the historical interested commodities and a plurality of interest prototypes to obtain a plurality of distance calculation results; and

taking the plurality of interest prototypes as a center to aggregate the representations of the historical interested commodities according to the plurality of distance calculation results to obtain the disentangled representations.

A second aspect of the embodiments of the present application provides a disentangled commodity recommendation apparatus, wherein the apparatus includes:

an information receiving module configured for receiving information of commodities to be recommended and historical behavioral information of a user, the historical behavioral information including a clicked commodity sequence, an unclicked commodity sequence, a disliked commodity sequence and behavioral time information of the user;

a representation filtering module configured for filtering the clicked commodity sequence and the unclicked commodity sequence according to the disliked commodity sequence to obtain representations of interested commodities of the user;

a representation filtering module configured for filtering the representations of the interested commodities of the user according to the behavioral time information of the user and the information of the commodities to be recommended to obtain representations of historical interested commodities of the user;

a representation aggregating module configured for clustering and aggregating the representations of the historical interested commodities to obtain a plurality of disentangled representations of the user; and

a recommendation predicting module configured for determining whether the commodities to be recommended are the interested commodities of the user according to the plurality of disentangled representations.

Optionally, the method is implemented based on a commodity recommendation model, and training steps of the commodity recommendation model include:

taking a set composed of a plurality of groups of user information and corresponding commodity information thereof as a training set, and inputting the training set into the commodity recommendation model; and

selecting, by the commodity recommendation model, a sample with corresponding difficulty in the training set for learning according to a current learning state, and adjusting difficulty distribution of the sample at a corresponding rate, and obtaining a trained commodity recommendation model after learning.

Optionally, selecting, by the commodity recommendation model, the sample with corresponding difficulty in the training set for learning according to the current learning state, includes:

obtaining a corresponding loss value after the commodity recommendation model learns samples in the training set;

comparing the loss value with a preset hyper-parameter, and determining difficulties of learning the samples according to a comparison result; and

determining the sample with the corresponding difficulty for learning according to parameters of the commodity recommendation model.

Optionally, the representation filtering module includes:

a sequence encoding submodule configured for inputting the clicked commodity sequence, the unclicked commodity sequence and the disliked commodity sequence into an encoder based on a multi-head attention mechanism for encoding, to obtain representations of clicked commodities, representations of unclicked commodities and representations of disliked commodities;

a negative representation acquisition submodule configured for performing average pooling on the representations of the disliked commodities to obtain a negative tendency representation of the user; and

a representation filtering submodule configured for filtering the representations of the clicked commodities and the representations of the unclicked commodities based on the negative tendency representation to obtain the representations of the interested commodities of the user.

Optionally, the representation filtering module includes:

a similarity calculating submodule configured for performing similarity calculation between the representations of the clicked commodities and the representations of the unclicked commodities and the negative tendency representation; and

an interested commodity representation determining submodule configured for filtering the representations of the clicked commodities and the representations of the unclicked commodities according to a similarity calculation result to obtain the representations of the interested commodities of the user.

Optionally, the representation filtering module includes:

a first representation filtering submodule configured for performing corresponding weight assignment on the representations of the interested commodities according to the behavioral time information;

a second representation filtering submodule configured for performing corresponding weight assignment on the representations of the interested commodities according to the information of the commodities to be recommended; and

a historical interested commodity representation determining submodule configured for taking the representations of the interested commodities after the weight assignment as the representations of the historical interested commodities of the user.

Optionally, the representation aggregating module includes:

a distance calculating submodule configured for calculating a distance between the representations of the historical interested commodities and a plurality of interest prototypes to obtain a plurality of distance calculation results; and

a representation aggregating submodule configured for taking the plurality of interest prototypes as a center to aggregate the representations of the historical interested commodities according to the plurality of distance calculation results to obtain the plurality of disentangled representations.

A third aspect of the embodiments of the present application provides computer-readable storage medium storing a computer program thereon, wherein the program, when executed by a processor, implements the steps of the method according to the first aspect of the present application.

A fourth aspect of the embodiments of the present application provides an electronic device including a memory, a processor, and a computer program stored in the memory and running on the processor, wherein the processor, when executing the computer program, implements the steps of the method according to the first aspect of the present application.

The disentangled commodity recommendation method proposed by the present application is used for receiving the information of the commodities to be recommended and the historical behavioral information of the user, the historical behavioral information including the clicked commodity sequence, the unclicked commodity sequence, the disliked commodity sequence and the behavioral time information of the user; filtering the clicked commodity sequence and the unclicked commodity sequence according to the disliked commodity sequence to obtain the representations of the interested commodities of the user; filtering the representations of the interested commodities of the user according to the behavioral time information of the user and the information of the commodities to be recommended to obtain the representations of the historical interested commodities of the user; clustering and aggregating the representations of the historical interested commodities to obtain the plurality of disentangled representations of the user; and determining whether the commodities to be recommended are the interested commodities of the user according to the plurality of disentangled representations. The disentangled representations of the user are obtained through the multi-feedback data of the user, that is, the clicked commodity sequence, the unclicked commodity sequence and the disliked commodity sequence, meanwhile, the interest of the user is accurately captured, recommendation accuracy is improved, and a click-through rate of the user is increased.

### BRIEF DESCRIPTION OF THE DRAWINGS

In order to more clearly illustrate the technical solutions of the embodiments of the present application, the figures to describe the embodiments of the present application will be briefly introduced below. Apparently, the figures that are described below are only some embodiments of the present application, and those of ordinary skills in the art can obtain other figures according to these figures without paying creative work.

FIG.1 is a flow chart of a disentangled recommendation method proposed according to an embodiment of the present application;

FIG. 2 is a schematic diagram of a disentangled recommendation process and controllable self-evaluation curriculum learning proposed according to an embodiment of the present application; and

FIG. 3 is a schematic diagram of a disentangled recommendation apparatus proposed according to an embodiment of the present application.

### DETAILED DESCRIPTION OF THE EMBODIMENTS

Hereinafter, the technical solutions in the embodiments of the present application are illustrated clearly and completely with the accompanying figures in the embodiments of the present application. Apparently, the described embodiments are merely some but not all of the embodiments of the present application. Based on the embodiments in the present application, all other embodiments obtained by those of ordinary skills in the art without going through any creative effort shall fall within the scope of protection of the present application.

The embodiments of the present application are implemented based on a commodity recommendation model. The model may be used in web pages or APPs. The commodity recommendation model is used to determine whether commodities to be recommended are commodities interested by a user, and determine whether to recommend the commodities to the user according to a determination result.

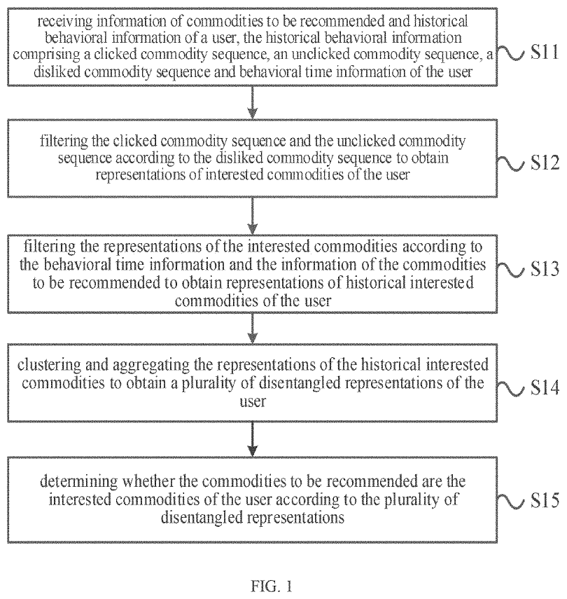

With reference to FIG. 1, FIG. 1 is a flow chart of a disentangled recommendation method proposed according to an embodiment of the present application. As shown in FIG. 1, the method includes the following steps.

S11: receiving information of commodities to be recommended and historical behavioral information of a user, the historical behavioral information including a clicked commodity sequence, an unclicked commodity sequence, a disliked commodity sequence and behavioral time information of the user.

In the present embodiment, the information of commodities to be recommended is a sequence of the commodities to be recommended, and the sequence contains names of the commodities to be recommended, categories and usage of recommended commodities, and the like. The clicked commodity sequence of the user is a sequence of commodities clicked by the user when browsing a commodity list; the unclicked commodity sequence of the user is a sequence of commodities unclicked by the user when browsing the commodity list; and the disliked commodity sequence of the user is a sequence of commodities marked as disliked commodities by the user when browsing the commodity list. The commodity sequence contains names, categories and usage of the commodities, and the behavioral time information contains the time when the user clicks the commodity.

In the present embodiment, the historical behavioral information of the user is multi-feedback information of the user received by the commodity recommendation model, and the historical behavioral information may be click behaviors of the user on the commodity within a period of time recorded by a website or an APP.

In the embodiment, the commodities to be recommended may be the commodities that the web page or APP wants to recommend to the user when the user browses a shopping web page or APP. A sequence of all commodities may be a sequence obtained through feature extraction performed by a word embedding network. The categories of the commodities may be clothing, electronic products, etc.

For example, the commodity clicked by the user may be jeans, which belongs to a clothing category, and the commodity disliked by the user may be a commodity for which the user clicked a dislike button or a commodity for which the user has complained.

S12: filtering the clicked commodity sequence and the unclicked commodity sequence according to the disliked commodity sequence to obtain representations of interested commodities of the user.

In the present embodiment, the commodities in the disliked commodity sequence are the commodities obviously marked as disliked commodities by the user. Therefore, the disliked commodities can be used as negative samples, while the commodities in the clicked sequence of the user may also contain the commodities that the user dislikes. The unclicked sequence may also contain the commodities that the user like, so it is necessary to filter the clicked commodity sequence and the unclicked commodity sequence through the disliked commodity sequence, and perform weight assignment on the corresponding representations of the clicked commodity sequence and the unclicked commodity sequence. The specific steps are as follows:

S12-1: inputting the clicked commodity sequence, the unclicked commodity sequence and the disliked commodity sequence into an encoder based on a multi-head attention mechanism for encoding, to obtain representations of clicked commodities, representations of unclicked commodities and representations of disliked commodities.

In the present embodiment, the encoder based on the multi-head attention mechanism is used for converting an initialization sequence of point-input commodities into representations of the commodities, and these representations can more accurately reflect features of the commodities and are beneficial to next filtering of a whole neural network model.

In the present embodiment, when processing the initialization sequence of the commodities, the encoder based on the multi-head attention mechanism can pay more attention to a key part of the sequence reflecting the features of the commodities, so that the extracted features can better reflect attributes of the commodities, thus ensuring an accuracy of interest mining.

S12-2: performing average pooling on the representations of the disliked commodities to obtain a negative tendency representation of the user.

In the present embodiment, the commodities that the user dislikes are marked by the user actively and marked as the disliked commodities, so a confidence level of the representations of the disliked commodities is higher, and a unified representation can be obtained by performing average pooling on these representations, and the representation is regarded as the negative tendency representation of the user.

In the present embodiment, the average pooling is carried out through a pooling layer in the commodity recommendation model.

S12-3: filtering the representations of the clicked commodities and the representations of the unclicked commodities based on the negative tendency representation to obtain the representations of the interested commodities of the user.

In the present embodiment, it is necessary to filter the representations of the clicked commodities and the representations of the unclicked commodities of the user based on the negative tendency representation to obtain the representations of the interested commodities of the user. The representations of the interested commodities of the user are the representations obtained after filtering. The specific steps include:

S12-3-1: performing similarity calculation between the representations of the clicked commodities and the representations of the unclicked commodities and the negative tendency representation.

S12-3-2: filtering the representations of the clicked commodities and the representations of the unclicked commodities according to a similarity calculation result to obtain the representations of the interested commodities of the user.

In the present embodiment, it is necessary to perform similarity calculation between the representations of all of the clicked commodities and the negative tendency representation, and perform similarity calculation between the representations of all of the unclicked commodities and the negative tendency representation, and filter the representations of the clicked commodities and the representations of the unclicked commodities according to the similarity calculation result, so as to obtain the representations of the interested commodities of the user.

If the similarity between the representation corresponding to a certain commodity and the negative tendency representation is low, it is indicated that the commodity corresponding to the representation is quite different from the commodities that the user dislike, and it is more likely to belong to the commodities that the user like. If the similarity between the representation corresponding to a certain commodity with the negative tendency representation is higher, it is indicated that the commodity corresponding to the representation is likely to belong to the commodities that the user dislike. For a representation with lower similarity to the negative tendency representation, a higher weight is assigned to this representation, and the representation with a higher weight greatly affects a finally fused representation when fusing representations. For a representation with higher similarity to the negative tendency representation, an extremely low weight is assigned to this representation, and this representation may not affect the finally aggregated representation when aggregating representations. Each of the representations of the plurality of interested commodities of the users is a representation obtained after filtering the representations of the clicked commodities and the representations of the unclicked commodities, i.e., performing weight assignment on each representation according to the similarity calculation result and then aggregating the representations. After filtering, the weights of the representations of the interested commodities of the user are higher, while the weights of the representations of the commodities that the user dislikes are lower.

For example, in the historical behavioral information of the user, the clicked commodities include a mobile phone, a tablet computer and a TV, wherein the TV is clicked by the user by mistake, but in fact, the user does not need a TV. There are also unclicked commodities in this page, such as a digital camera, a smart bracelet, an electronic watch and a TV. When the user accidentally clicks on the TV again, the TV is marked as a disliked commodity. After the historical behavioral information is input into a commodity recommendation network, the commodity recommendation network performs average pooling on the sequence corresponding to the TV, filters the representations of the clicked commodities and the representations of the unclicked commodities, assigns higher weights to the representations corresponding to the mobile phone, the tablet computer, the digital camera, the smart bracelet, a smart watch and the electronic watch, and assigns an extremely low weight to the representation corresponding to the TV.

In the present embodiment, the representations corresponding to the commodities are filtered based on the negative representation, that is, considering that there may be commodities that the user dislikes in the commodities clicked by the user, and there are also interested commodities of the user in the unclicked commodities of the user, the influence of noises on a commodity recommendation effect is reduced from a feature level.

S13: filtering the representations of the interested commodities of the user according to the behavioral time information of the user and the information of the commodities to be recommended to obtain representations of historical interested commodities of the user.

In the present embodiment, the specific steps of filtering the representations of the interested commodities of the user according to the behavioral time information of the user and the information of the commodities to be recommended to obtain the representations of the historical interested commodities of the user are:

S13-1: performing corresponding weight assignment on the representations of the interested commodities according to the behavioral time information.

In the present embodiment, the behavioral time information is contained in the historical behavioral information of the user, and the representations of the interested commodities of the user obtained after the previous step of filtering contain the representations of the clicked commodities. The representations are filtered according to the behavioral time of the commodities corresponding to the representations. The representation corresponding to the commodity with the behavioral time close to the current time is assigned with a higher weight, and the representation corresponding to the commodity with the behavioral time far away from the current time is assigned with a very low weight. When aggregating the representations, the commodity with the behavioral time far away from the current time may not affect the aggregated result.

In the present embodiment, the commodity recommendation model may assign a weight to the representation of each commodity according to the behavioral time, thus avoiding an influence of the commodity with the behavioral time far away from the current time on a recommendation result.

S13-2: performing corresponding weight assignment on the representations of the interested commodities according to the behavioral time information.

In the present embodiment, the information of commodities to be recommended contains the representations of the commodities to be recommended. When the representations of the interested commodities of the user are too different from the representations of the commodities to be recommended, the representations are given a very low weight. When aggregating the representations, the representations will not affect the aggregated result. When the difference between the representations of the commodities and the representations of the commodities to be recommended is small, it is indicated that the two commodities are similar. When aggregating the representations, the representations greatly affect the fusing result, which is beneficial to recommending interested commodities to the user.

S13-3: taking the representations of the interested commodities after the weight assignment as the representations of the historical interested commodities of the user.

S14: clustering and aggregating the representations of the historical interested commodities to obtain a plurality of disentangled representations of the user.

In the present embodiment, the specific steps of clustering and aggregating the representations of the historical interested commodities to obtain the plurality of disentangled representations of the user include:

S14-1: calculating a distance between the representations of the historical interested commodities and a plurality of interest prototypes to obtain a plurality of distance calculation results.

In the present embodiment, the interest prototypes refer to the category representations of the commodities, and the distance between the representations of the historical interested commodities and the interest prototypes is a distance between the two in a representation space.

In the representation space, the distance between two representations with higher similarity is relatively close. When calculating a distance between the representations of the interested commodities and the interest prototypes, when the distance is less than a certain threshold, it is indicated that the commodities belong to the interest prototypes.

For example, the categories corresponding to the interest prototypes can be clothing, snacks, sporting goods and the like. When the commodities are pants, the representations of the commodities are closer to the interest prototype of clothing. When the commodities are biscuits and spicy strips, the representations of the commodities are closer to the interest prototype of snacks, and when the commodities are basketball and football, the representations of the commodities are closer to the interest prototype of sporting goods.

S14-2: taking the plurality of interest prototypes as a center to aggregate the representations of the historical interested commodities according to the plurality of distance calculation results to obtain the plurality of disentangled representations.

In the present embodiment, the distance between the representation of each historical interest commodity and the interest prototypes can be known according to the plurality of distance calculation results, and the representation of each historical interested commodity has a closest interest prototype. Taking the plurality of interest prototypes as the center, the representations of the closest historical interest commodities are aggregated to obtain a plurality of disentangled representations, which represent the representations of the historical interest commodities of the same category.

For example, when the commodities are pants and clothing, the representations of the commodities are closer to the interest prototype of clothing interest, and the representations of pants and clothes are aggregated to obtain a disentangled representation, which reflects the preference of the user for clothing-type commodities. When the commodities are biscuits and spicy strips, the representations of the commodities are closer to the interest prototype of snacks, and the representations corresponding to biscuits and spicy strips are aggregated to obtain a disentangled representation, which reflects the preference of the user for snacks commodities. When the commodities are basketball and football, the representations of the commodities are closer to the interest prototype of sporting goods, and the representations corresponding to basketball and football are aggregated to obtain a disentangled representation, which reflects the preference of the user for sporting goods.

Determining whether the commodities to be recommended are the interested commodities of the user according to the plurality of disentangled representations.

In the present embodiment, after obtaining the plurality of disentangled representations, the similarity between the representations of the commodities to be recommended and the plurality of disentangled representations is calculated, and it can be obtained through the calculation result that which representation that the representations of the commodities to be recommended is closer to, so as to determine which category the commodities to be recommended belong to, and then determine whether the commodities to be recommended are the interested commodities of the user according to the features of the commodities and the information of the user.

For example, the commodities to be recommended are basketball shoes, and the representations of the commodities are closer to the representations of clothing and sporting goods. If the information of the user indicates that the user is male, the commodities to be recommended are likely to be the interested commodities of the user, and the commodities are determined to be the interested commodities of the user. At the beginning, the user information may be input into a model of commodities to be recommended together with the historical behavioral information of the user.

In the present embodiment, the disentangled representations of the user are obtained from the multi-feedback data of the user, the interest of the user is accurately captured, and the accuracy of recommending commodities is improved.

In another embodiment of the present application, training steps of the commodity recommendation model include:

S21: taking a set composed of a plurality of groups of user information and corresponding commodity information thereof as a training set, and inputting the training set into the commodity recommendation model.

S22: selecting, by the commodity recommendation model, a sample with corresponding difficulty in the training set for learning according to a current learning state, and adjusting difficulty distribution of the sample at a corresponding rate, and obtaining a trained commodity recommendation model after learning.

In the present embodiment, the user information includes ID information of the user, the historical behavioral information of the user, and the like. The commodity information includes the name, the category, the usage and other information of the commodity, and also marks whether the commodity is the interested commodity of the user.

In the model training process, the model may select the sample with corresponding difficulty in the training set for learning according to the current learning state, that is, the parameters currently obtained by the model. In other words, samples with lower learning difficulty may be learned first, and then samples with higher learning difficulty may be learned, and the difficulty distribution of the samples may be adjusted through the corresponding rate, that is, the samples in the whole training set may be learned gradually at a certain rate, instead of being limited to the samples with lower learning difficulty.

For example, the rate of adjusting the difficulty may be that the difficulty of the learned samples is adjusted once every 10 rounds of training, and finally the learned samples are gradually covered in the whole training set, to dynamically adjust the difficulty distribution of the samples.

The selecting, by the commodity recommendation model, the sample with corresponding difficulty in the training set for learning according to the current learning state,

S21-1: obtaining a corresponding loss value after the commodity recommendation model learns samples in the training set.

S21-2 : comparing the loss value with a preset hyper-parameter, and determining difficulties of learning the samples according to a comparison result.

S21-3: determining the sample with the corresponding difficulty for learning according to parameters of the commodity recommendation model.

In the present embodiment, before training the commodity recommendation model, the hyper-parameter may be preset, which defines some parameters in the model, and these parameters may not change during the training, such as dimensions of each layer of the model and an expected loss value of the model. After learning the sample in the commodity recommendation model, one loss value may be obtained, and the loss value is compared with the preset hyper-parameter. If the loss value is close to a value set in the hyper-parameter, a weight of the learned sample is increased, and the sample is learnt more carefully. After learning the sample, samples with a big difference between the loss value and the value set in the hyper-parameter are gradually selected for learning.

For example, if the expected loss value set in the hyper-parameter is 0.5, the samples with a loss value of 0.5 are learnt first, and then the samples with loss values of 0.4, 0.6, 0.7 and 0.8 are learnt, to finish learning the whole training set and obtain the trained commodity recommendation model.

In the present embodiment, by dynamically adjusting the difficulty of the learnt samples, an appropriate learning strategy is selected for the model as much as possible, so that the model is not affected by noises and falls into a local optimal point. Moreover, the difficulty of data and the selection of learning rate are set by the hyper-parameter, which is conveniently applied to the learning of various data sets without introducing additional training parameters, thus ensuring a training efficiency of the model and an effect of the trained model.

In another embodiment of the present application, the trained commodity recommendation model is tested. If a test result of the commodity recommendation model is not ideal, that is, a success rate of commodity recommendation is not high, the hyper-parameter of the model may be adaptively modified, and then the commodity recommendation model may be further trained.

In another embodiment of the present application, the present application is further explained with reference to a schematic diagram of a disentangled recommendation process and controllable self-evaluation curriculum learning.

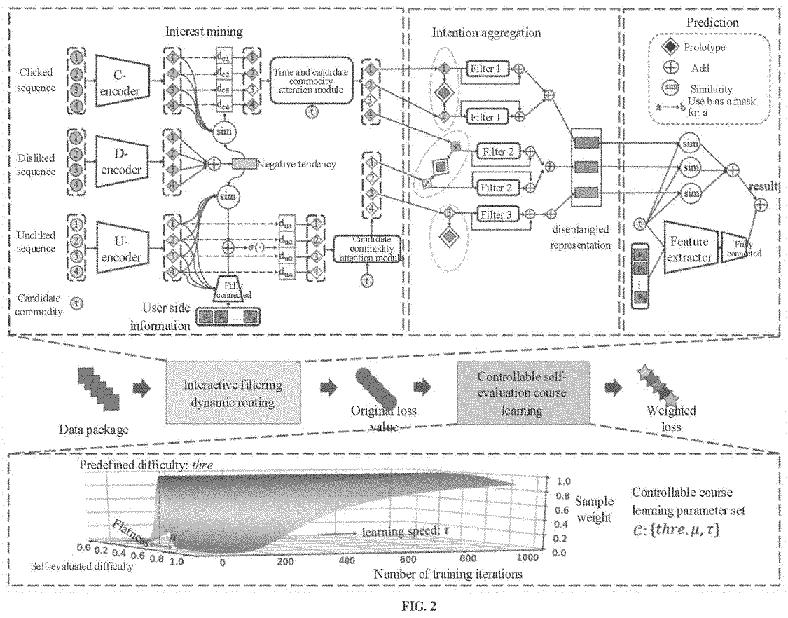

As shown in FIG. 2, FIG. 2 is a schematic diagram of a disentangled recommendation process and controllable self-evaluation curriculum learning proposed according to an embodiment of the present application, wherein C, D and U represent encoder models, d_{c} and dᵤ represent vector weights, and F represents user information.

As shown in FIG, 2, in an interactive filtering dynamic routing module, there are three steps: interest mining, intention aggregation and prediction.

In the step of interest mining, clicked sequences (1, 2, 3 and 4, respectively representing different commodities) are input into the C encoder to obtain representations of commodities clicked by the users. Similarly, representations of disliked commodities and representations of unclicked commodities are obtained. After that, a negative tendency is obtained by performing average pooling on the representations of the disliked commodities. Based on this negative tendency, the representations of the clicked commodities and the representations of the unclicked commodities are filtered. It can be seen from the figure that in the clicked commodity sequence, a background of the representation 3 becomes lighter, which means that the representation 3 is assigned with an extremely low weight, while in the unclicked commodity sequence, the representation 4 is assigned with an extremely low weight. After passing through a time and candidate commodity attention module, the representation 4 of the unclicked sequence is assigned with an extremely low weight.

In the intention aggregation step, the remaining representations are intentionally aggregated, wherein the representation 1 and the representation 2 in the clicked sequence are aggregated into one disentangled representation, the representation 4 in the clicked sequence and the representation 1 in the unclicked sequence are aggregated into one disentangled representation, and the representation 3 in the unclicked sequence is individually aggregated into one disentangled representation, thus obtaining three disentangled representations.

In the prediction step, similarity calculation is performed between the three disentangled representations and the representations of the commodities and then added, and a final result is obtained by combining the user side information, so as to determine whether the commodities to be recommended are the interested commodities of the user.

In a controllable self-evaluation curriculum learning module, the learning process of the whole model obeys Gaussian distribution, and the figure shows a three-dimensional coordinate so axis. The difficulty of the learned samples expands continuously with the change of training rounds until the whole training set is learned.

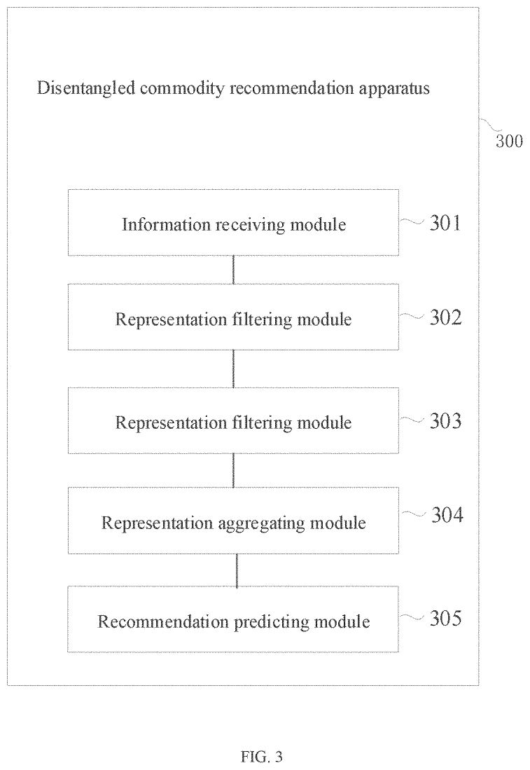

Based on the same inventive concept, an embodiment of the present application provides a disentangled commodity recommendation apparatus. With reference to FIG. 3, FIG. 3 is a schematic diagram of the disentangled commodity recommendation apparatus 300 proposed according to an embodiment of the present application. As shown in FIG. 3, the apparatus includes:

an information receiving module 301 configured for receiving information of commodities to be recommended and historical behavioral information of a user, the historical behavioral information including a clicked commodity sequence, an unclicked commodity sequence, a disliked commodity sequence and behavioral time information of the user;

a representation filtering module 302 configured for filtering the clicked commodity sequence and the unclicked commodity sequence according to the disliked commodity sequence to obtain representations of interested commodities of the user;

a representation filtering module 303 configured for filtering the representations of the interested commodities of the user according to the behavioral time information of the user and the information of the commodities to be recommended to obtain representations of historical interested commodities of the user;

a representation aggregating module 304 configured for clustering and aggregating the representations of the historical interested commodities to obtain a plurality of disentangled representations of the user; and

a recommendation predicting module 305 configured for determining whether the commodities to be recommended are the interested commodities of the user according to the plurality of disentangled representations.

Optionally, the method is implemented based on a commodity recommendation model, and training steps of the commodity recommendation model include:

taking a set composed of a plurality of groups of user information and corresponding commodity information thereof as a training set, and inputting the training set into the commodity recommendation model; and

selecting, by the commodity recommendation model, a sample with corresponding difficulty in the training set for learning according to a current learning state, and adjusting difficulty distribution of the sample at a corresponding rate, and obtaining a trained commodity recommendation model after learning.

Optionally, selecting, by the commodity recommendation model, the sample with corresponding difficulty in the training set for learning according to the current learning state, includes:

obtaining a corresponding loss value after the commodity recommendation model learns samples in the training set;

comparing the loss value with a preset hyper-parameter, and determining difficulties of learning the samples according to a comparison result; and

determining the sample with the corresponding difficulty for learning according to parameters of the commodity recommendation model.

Optionally, the representation filtering module includes:

a sequence encoding submodule configured for inputting the clicked commodity sequence, the unclicked commodity sequence and the disliked commodity sequence into an encoder based on a multi-head attention mechanism for encoding, to obtain representations of clicked commodities, representations of unclicked commodities and representations of disliked commodities;

a negative representation acquisition submodule configured for performing average pooling on the representations of the disliked commodities to obtain a negative tendency representation of the user; and

a representation filtering submodule configured for filtering the representations of the clicked commodities and the representations of the unclicked commodities based on the negative tendency representation to obtain the representations of the interested commodities of the user.

Optionally, the representation filtering module includes:

a similarity calculating submodule configured for performing similarity calculation between the representations of the clicked commodities and the representations of the unclicked commodities and the negative tendency representation; and

an interested commodity representation determining submodule configured for filtering the representations of the clicked commodities and the representations of the unclicked commodities according to a similarity calculation result to obtain the representations of the interested commodities of the user.

Optionally, the representation filtering module includes:

a first representation filtering submodule configured for performing corresponding weight assignment on the representations of the interested commodities according to the behavioral time information;

a second representation filtering submodule configured for performing corresponding weight assignment on the representations of the interested commodities according to the information of the commodities to be recommended; and

a historical interested commodity representation determining submodule configured for taking the representations of the interested commodities after the weight assignment as the representations of the historical interested commodities of the user.

Optionally, the representation aggregating module includes:

a distance calculating submodule configured for calculating the distance between the representations of the historical interested commodities and a plurality of interest prototypes to obtain a plurality of distance calculation results; and

a representation aggregating submodule configured for taking the plurality of interest prototypes as a center to aggregate the representations of the historical interested commodities according to the plurality of distance calculation results to obtain the plurality of disentangled representations.

Based on the same inventive concept, another embodiment of the present application provides a readable storage medium storing a computer program thereon, wherein the program, when executed by a processor, implements the steps of the disentangled commodity recommendation method described in any of the above embodiments of the present application.

Based on the same inventive concept, another embodiment of the present application provides an electronic device including a memory, a processor, and a computer program stored in the memory and miming on the processor. When executed, the processor realizes the steps of the disentangled commodity recommendation method described in any of the above embodiments of the present application.

As for the device embodiment, since it is basically similar to the method embodiment, the description of the device embodiment is relatively simple. For relevant points, please refer to the partial description of the method embodiment.

Each embodiment in this specification is described in a progressive way, each embodiment focuses on the differences from other embodiments, and the same and similar parts between the embodiments may be referred to each other.

It should be appreciated by those skilled in this art that the embodiments of the present application may be provided as methods, device or computer program products. Therefore, the embodiments of the present application may take the form of complete hardware embodiments, complete software embodiments or software-hardware combined embodiments. Moreover, the embodiments of the present application may take the form of a computer program product embodied on one or more computer usable storage media (including but not limited to disk storage, CD-ROM, optical storage, etc.) in which computer usable program codes are included.

The embodiments of the present application are described with reference to the flow charts and/or block diagrams of the method, terminal device (system), and computer program products according to the embodiments of the present application. It should be appreciated that each flow and/or block in the flow charts and/or block diagrams, and combinations of the flows and/or blocks in the flow charts and/or block diagrams may be implemented by computer program instructions. These computer program instructions may be provided to a general purpose computer, a special purpose computer, an embedded processor, or a processor of other programmable data processing terminal device to produce a machine for the instructions executed by the computer or the processor of other programmable data processing terminal device to generate an apparatus for implementing the functions specified in one or more flows of the flow chart and/or in one or more blocks of the block diagram.

These computer program instructions may also be provided to a computer readable memory that can guide the computer or other programmable data processing terminal device to work in a given manner, so that the instructions stored in the computer readable memory generate a product including an instruction apparatus that implements the functions specified in one or more flows of the flow chart and/or in one or more blocks of the block diagram.

These computer program instructions may also be loaded to a computer, or other programmable terminal device, so that a series of operating steps are executed on the computer, or other programmable terminal device to produce processing implemented by the computer, so that the instructions executed in the computer or other programmable terminal device provide steps for implementing the functions specified in one or more flows of the flow chart and/or in one or more blocks of the block diagram.

Although the preferred embodiments of the present application have been described, those skilled in the art can make additional changes and modifications to these embodiments once they know the basic inventive concepts. Therefore, the appended claims are intended to be interpreted as including the preferred embodiments and all the changes and modifications that fall within the scope of the embodiments of the present application.

Finally, it should be also noted that relational terms herein such as first and second, etc., are used merely to distinguish one entity or operation from another entity or operation, and do not necessarily require or imply there is any such relationship or order between these entities or operations. Furthermore, the terms “including”, “including” or any variations thereof are intended to embrace a non-exclusive inclusion, such that a process, method, article, or terminal device including. a plurality of elements includes not only those elements but also includes other elements not expressly listed, or also includes elements inherent to such a process, method, item, or terminal device. In the absence of further limitation, an element defined by the phrase “including a . . . ” does not exclude the presence of additional identical element in the process, method, article, or terminal device.

The disentangled commodity recommendation method and apparatus, the device and the storage medium provided by the present application are described in detail above. Specific examples are applied to explain the principle and implementation of the present application herein. The above embodiments are only used to help understand the method of the present application and the core idea thereof. Meanwhile, for those of ordinary skills in the art, there will be changes in the specific implementation and application scope according to the idea of the present application. To sum up, the contents of this specification should not be construed as limiting the present application.

What is claimed is:

1. A disentangled commodity recommendation method, wherein the method comprises:
receiving information of commodities to be recommended and historical behavioral information of a user, the historical behavioral information comprising a clicked commodity sequence, an unclicked commodity sequence, a disliked commodity sequence and behavioral time information of the user;
filtering the clicked commodity sequence and the unclicked commodity sequence according to the disliked commodity sequence to obtain representations of interested commodities of the user;
filtering the representations of the interested commodities according to the behavioral time information and the information of the commodities to be recommended to obtain representations of historical interested commodities of the user;
clustering and aggregating the representations of the historical interested commodities to obtain a plurality of disentangled representations of the user; and
determining whether the commodities to be recommended are the interested commodities of the user according to the plurality of disentangled representations;
wherein filtering the clicked commodity sequence and the unclicked commodity sequence according to the disliked commodity sequence to obtain the representations of the interested commodities of the user, comprises:
inputting the clicked commodity sequence, the unclicked commodity sequence and the disliked commodity sequence into an encoder based on a multi-head attention mechanism for encoding, to obtain representations of clicked commodities, representations of unclicked commodities and representations of disliked commodities;
performing average pooling on the representations of the disliked commodities to obtain a negative tendency representation of the user; and
filtering the representations of the clicked commodities and the representations of the unclicked commodities based on the negative tendency representation to obtain the representations of the interested commodities of the user.

2. The disentangled commodity recommendation method according to claim 1, wherein the disentangled commodity recommendation method is implemented based on a commodity recommendation model, and training steps of the commodity recommendation model comprise:
taking a set composed of a plurality of groups of user information and commodity information corresponding to the plurality of groups of user information as a training set, and inputting the training set into the commodity recommendation model; and
selecting, by the commodity recommendation model, a sample with corresponding difficulty in the training set for learning according to a current learning state, adjusting difficulty distribution of the sample at a corresponding rate, and obtaining a trained commodity recommendation model after learning.

3. The disentangled commodity recommendation method according to claim 2, wherein selecting, by the commodity recommendation model, the sample with corresponding difficulty in the training set for learning according to the current learning state, comprises:
obtaining a corresponding loss value after the commodity recommendation model learns samples in the training set;
comparing the loss value with a preset hyper-parameter, and determining difficulties of learning the samples according to a comparison result; and
determining the sample with the corresponding difficulty for learning according to parameters of the commodity recommendation model.

4. The disentangled commodity recommendation method according to claim 3, wherein filtering the representations of the clicked commodities and the representations of the unclicked commodities based on the negative tendency representation to obtain the representations of the interested commodities of the user, comprises:
performing similarity calculation between the representations of the clicked commodities and the representations of the unclicked commodities and the negative tendency representation; and
filtering the representations of the clicked commodities and the representations of the unclicked commodities according to a similarity calculation result to obtain the representations of the interested commodities of the user.

5. The disentangled commodity recommendation method according to claim 1, wherein filtering the representations of the interested commodities of the user according to the behavioral time information of the user and the information of the commodities to be recommended to obtain the representations of the historical interested commodities of the user, comprises:
performing corresponding weight assignment on the representations of the interested commodities according to the behavioral time information;
performing corresponding weight assignment on the representations of the interested commodities according to the information of the commodities to be recommended; and
taking the representations of the interested commodities after the weight assignment as the representations of the historical interested commodities of the user.

6. The disentangled commodity recommendation method according to claim 1, wherein clustering and aggregating the representations of the historical interested commodities to obtain the plurality of disentangled representations of the user, comprises:
calculating a distance between the representations of the historical interested commodities and a plurality of interest prototypes to obtain a plurality of distance calculation results; and
taking the plurality of interest prototypes as a center to aggregate the representations of the historical interested commodities according to the plurality of distance calculation results to obtain the plurality of disentangled representations.

7. A computer-readable storage medium storing a computer program thereon, wherein the computer program, when executed by a processor, implements steps of the disentangled commodity recommendation method according to claim 1.

8. An electronic device comprising a memory, a processor, and a computer program stored in the memory and running on the processor, wherein the processor, when executing the computer program, implements steps of the disentangled commodity recommendation method according to claim 1.

9. The computer-readable storage medium according to claim 7, wherein the disentangled commodity recommendation method is implemented based on a commodity recommendation model, and training steps of the commodity recommendation model comprise:
taking a set composed of a plurality of groups of user information and commodity information corresponding to the plurality of groups of user information as a training set, and inputting the training set into the commodity recommendation model; and
selecting, by the commodity recommendation model, a sample with corresponding difficulty in the training set for learning according to a current learning state, adjusting difficulty distribution of the sample at a corresponding rate, and obtaining a trained commodity recommendation model after learning.

10. The computer-readable storage medium according to claim 9, wherein selecting, by the commodity recommendation model, the sample with corresponding difficulty in the training set for learning according to the current learning state, comprises:
obtaining a corresponding loss value after the commodity recommendation model learns samples in the training set;
comparing the loss value with a preset hyper-parameter, and determining difficulties of learning the samples according to a comparison result; and
determining the sample with the corresponding difficulty for learning according to parameters of the commodity recommendation model.

11. The computer-readable storage medium according to claim 7, wherein filtering the clicked commodity sequence and the unclicked commodity sequence according to the disliked commodity sequence to obtain the representations of the interested commodities of the user, comprises:
inputting the clicked commodity sequence, the unclicked commodity sequence and the disliked commodity sequence into an encoder based on a multi-head attention mechanism for encoding, to obtain representations of clicked commodities, representations of unclicked commodities and representations of disliked commodities;
performing average pooling on the representations of the disliked commodities to obtain a negative tendency representation of the user; and
filtering the representations of the clicked commodities and the representations of the unclicked commodities based on the negative tendency representation to obtain the representations of the interested commodities of the user.

12. The computer-readable storage medium according to claim 10, wherein filtering the representations of the clicked commodities and the representations of the unclicked commodities based on the negative tendency representation to obtain the representations of the interested commodities of the user, comprises:
performing similarity calculation between the representations of the clicked commodities and the representations of the unclicked commodities and the negative tendency representation; and
filtering the representations of the clicked commodities and the representations of the unclicked commodities according to a similarity calculation result to obtain the representations of the interested commodities of the user.

13. The computer-readable storage medium according to claim 7, wherein filtering the representations of the interested commodities of the user according to the behavioral time information of the user and the information of the commodities to be recommended to obtain the representations of the historical interested commodities of the user, comprises:
performing corresponding weight assignment on the representations of the interested commodities according to the behavioral time information;
performing corresponding weight assignment on the representations of the interested commodities according to the information of the commodities to be recommended; and
taking the representations of the interested commodities after the weight assignment as the representations of the historical interested commodities of the user.

14. The computer-readable storage medium according to claim 7, wherein clustering and aggregating the representations of the historical interested commodities to obtain the plurality of disentangled representations of the user, comprises:
calculating a distance between the representations of the historical interested commodities and a plurality of interest prototypes to obtain a plurality of distance calculation results; and
taking the plurality of interest prototypes as a center to aggregate the representations of the historical interested commodities according to the plurality of distance calculation results to obtain the plurality of disentangled representations.

15. The electronic device according to claim 8, wherein the disentangled commodity recommendation method is implemented based on a commodity recommendation model, and training steps of the commodity recommendation model comprise:
taking a set composed of a plurality of groups of user information and commodity information corresponding to the plurality of groups of user information as a training set, and inputting the training set into the commodity recommendation model; and
selecting, by the commodity recommendation model, a sample with corresponding difficulty in the training set for learning according to a current learning state, adjusting difficulty distribution of the sample at a corresponding rate, and obtaining a trained commodity recommendation model after learning.

16. The electronic device according to claim 15, wherein selecting, by the commodity recommendation model, the sample with corresponding difficulty in the training set for learning according to the current learning state, comprises:
obtaining a corresponding loss value after the commodity recommendation model learns samples in the training set;
comparing the loss value with a preset hyper-parameter, and determining difficulties of learning the samples according to a comparison result; and
determining the sample with the corresponding difficulty for learning according to parameters of the commodity recommendation model.

17. The electronic device according to claim 8, wherein filtering the clicked commodity sequence and the unclicked commodity sequence according to the disliked commodity sequence to obtain the representations of the interested commodities of the user, comprises:
inputting the clicked commodity sequence, the unclicked commodity sequence and the disliked commodity sequence into an encoder based on a multi-head attention mechanism for encoding, to obtain representations of clicked commodities, representations of unclicked commodities and representations of disliked commodities:
performing average pooling on the representations of the disliked commodities to obtain a negative tendency representation of the user; and
filtering the representations of the clicked commodities and the representations of the unclicked commodities based on the negative tendency representation to obtain the representations of the interested commodities of the user.

18. The electronic device according to claim 17, wherein filtering the representations of the clicked commodities and the representations of the unclicked commodities based on the negative tendency representation to obtain the representations of the interested commodities of the user, comprises:
performing similarity calculation between the representations of the clicked commodities and the representations of the unclicked commodities and the negative tendency representation; and
filtering the representations of the clicked commodities and the representations of the unclicked commodities according to a similarity calculation result to obtain the representations of the interested commodities of the user.

19. The electronic device according to claim 8, wherein filtering the representations of the interested commodities of the user according to the behavioral time information of the user and the information of the commodities to be recommended to obtain the representations of the historical interested commodities of the user, comprises:
performing corresponding weight assignment on the representations of the interested commodities according to the behavioral time information;
performing corresponding weight assignment on the representations of the interested commodities according to the information of the commodities to be recommended; and
taking the representations of the interested commodities after the weight assignment as the representations of the historical interested commodities of the user.

20. The electronic device according to claim 8, wherein clustering and aggregating the representations of the historical interested commodities to obtain the plurality of disentangled representations of the user, comprises:
calculating a distance between the representations of the historical interested commodities and a plurality of interest prototypes to obtain a plurality of distance calculation results; and
taking the plurality of interest prototypes as a center to aggregate the representations of the historical interested commodities according to the plurality of distance calculation results to obtain the plurality of disentangled representations.
